(19) United States
(12) Patent Application Publication
(10) Pub. No.: US 2024/0380423 A1
(43) Pub. Date: Nov. 14, 2024

(54) METHOD AND SYSTEM FOR ITERATIVE DOWNLINK PASSIVE INTERMODULATION SPATIAL AVOIDANCE

(71) Applicant: Telefonaktiebolaget LM Ericsson (publ), Stockholm (SE)

(72) Inventors: Pierre-Andre LAPORTE, Gatineau (CA); Mark WYVILLE, Ottawa (CA)

(21) Appl. No.: 18/689,705

(22) PCT Filed: Sep. 10, 2021
(86) PCT No.: PCT/IB2021/058271

§ 371 Date: Mar. 6, 2024

(51) Int. Cl. H04B 1/04; H04L 25/02

(52) U.S. Cl. CPC H04B 1/0475; H04L 25/0244; H04L 25/0248

(57) ABSTRACT

A method, network node and wireless transceiver, for implementing iterative downlink passive intermodulation (PIM) spatial avoidance algorithms are provided. According to one aspect, a method in a wireless transceiver includes determining an uplink signal power. The method also includes determining an estimate of a downlink PIM subspace that minimizes a cost function that depends on the uplink signal power and a previous estimate of the downlink PIM subspace. The method further includes applying a correction to a downlink antenna signal to reduce the PIM, the correction being based at least in part on the estimate of the downlink PIM subspace

### TECHNICAL FIELD

The present disclosure relates to wireless communication and in particular, to iterative downlink passive intermodulation (PIM) spatial avoidance algorithms and their implementation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

In network nodes operating as radio base stations, methods for reducing the downlink radiation pattern in the direction of external Passive-Intermodulation (PIM) sources in Frequency-Division Duplex (FDD) systems are desired. One such method is referred to as downlink PIM spatial avoidance. An FDD massive-multiple input multiple output (mMIMO) system model of a network node 2 with PIM interference is shown in FIG. 1. In the transmit path, control and traffic signals, b, in the layer domain are input to a precoder 4 to produce precoded control and traffic signals x, in the antenna domain. The precoded signals x undergo a downlink transformation according to the downlink channel matrix H_{DL_UE} 6 representing the channel response from the base station to the WDs. The precoded signals x also undergo a downlink transformation according to a downlink PIM channel matrix H_{DL_PIM} 8 representing the channel response from the network node 2 to the PIM sources for each of the downlink subcarriers.

In the receive path, uplink signals s from one or more wireless devices (WD) undergo an uplink transformation according to an uplink channel matrix H_{UL_UE} 10 representing the channel response from the WDs to the network node 2. The precoded signals x, after undergoing the downlink transformation according to the downlink channel matrix H_{DL_PIM} 8, also undergo Fourier transform processing and interaction with PIM sources h_{NL}, resulting in signals that further undergo an uplink transformation according to an uplink PIM channel matrix H_{UL_PIM} 12 representing the channel response from the PIM sources h_{NL} to the base station for each of the uplink subcarriers. The sums of signals from the uplink channel matrix H_{UL_UE} 10 and the uplink PIM channel matrix H_{UL_PIM} 12 are input to a decoder 14 to produce UL control and traffic signals s.

### The System Parameters May Include:

M downlink MIMO layers;
K uplink MIMO layers;
N downlink and uplink base station antennas;
ω_DL is the downlink channel frequency;
ω_UL is the uplink channel frequency;
I_s is the channel dimensions impacted by PIM—which could correspond to the total number of interference sources such as the number of PIM sources; and
N_L is the non-linear order of the PIM sources.

### The System Variables are Described as:

b is an M×1 vector of the DL control and traffic signaling in the layer domain;
x is an N×1 vector of the pre-coded DL control and traffic signaling in the antenna domain;
s is a K×1 vector of the UL control and traffic signaling in the layer domain at the WDs;
r is an N×1 vector of the UL received control and traffic signaling in the antenna domain at the base station;
H_{DL_UE} is an M×N matrix of the channel response from the base station to the WDs for each of the downlink subcarriers;
H_{UL_UE} is an N×K matrix of the channel response from the WDs to the base station for each of the uplink subcarriers;
H_{DL_PIM} is an Iₛ×N matrix of the channel response from the base station to the PIM sources for each of the downlink subcarriers;
H_{UL_PIM} is an N×Iₛ matrix of the channel response from the PIM sources to the base station for each of the uplink subcarriers;
h_{NL} are some non-linear time-domain models of the PIM sources;
W_{DL} is an N×M matrix of the beamforming weights for each of the DL subcarriers (PRB granularity may be used to reduce the implementation cost); and
W_{UL} is a K×N matrix of the beamforming weights for each of the UL subcarriers (PRB granularity may be used to reduce the implementation cost).

### Two Solutions May be Implemented Depending on the Situation:

1) Case 1: The downlink WD Channel State Information (CSI) is known as in reciprocity-based transmissions or NR Type-II codebook where the WD DL CSI can be reconstructed:

$$x = {\hat{R}}_{DL \_ PIM}^{- 1} \cdot {H}_{DL \_ UE}^{H} \cdot {( {H}_{DL \_ UE} \cdot {\hat{R}}_{DL \_ PIM}^{- 1} \cdot {H}_{DL \_ UE}^{H} )}^{- 1} \cdot b \qquad ( 1 )$$

$$where :$$

$$\begin{matrix}{R}_{DL \_ PIM} = {H}_{DL \_ PIM}^{H} \cdot {H}_{DL \_ PIM} \\ = {U}_{DL \_ PIM} \cdot {Σ}_{DL \_ PIM} \cdot {U}_{DL \_ PIM}^{H}\end{matrix} \qquad ( 2 )$$

U_{DL_PIM} is a N×N matrix formed by the N eigenvectors [u₀, . . . , u_{N-1}]:
   The signal subspace of the PIM channel covariance matrix corresponds to the Iₛ dominant eigenvectors U_{DL_PIM}=[u₀, . . . , u_{I}_{ₛ}₋₁]; and
   The noise subspace of the PIM channel covariance matrix corresponds to the remaining eigenvectors U_{DL_Noise}=[u_{I}_{ₛ}, . . . , u_{N-1}];
Σ is a N×N diagonal matrix with the diagonal elements set to the N downlink PIM channel covariance matrix eigenvalues λ₀, . . . , λ_{N-1}. The first elements λᵢ, i=0, . . . , Iₛ−1 are the PIM eigenvalues while the remaining entries λᵢ, i=Iₛ, . . . , N−1 are noise eigenvalues.
2) Case 2: The downlink WD CSI is unknown such as in open radio access network (ORAN) radios, LTE codebook or NR Type-I codebook:

$$x = ( I - {U}_{DL \_ PIM} \cdot {U}_{DL \_ PIM}^{H} ) \cdot {W}_{DL \_ CB} \cdot b \qquad ( 3 )$$

where W_{DL_CB}∈ [symbol] ^{N×M} is the matrix of the downlink codebook pre-coding weights.

In the above cases, it is assumed that the spatial behavior seen by the antenna array of the network node 2 (i.e., directions of arrival and departure) is similar in both the uplink and downlink. Under this assumption, the dominant downlink PIM eigenvectors—which correspond to the directions of departure at the antenna array—can be estimated using the uplink PIM directions of arrival.

The estimated downlink PIM covariance matrix R_{DL_PIM} is expressed in terms of the uplink PIM covariance matrix R_{UL_PIM} subject to an electrical transform to compensate for the different inter-element antenna spacing between the uplink and the downlink bands as follows:

$${\hat{R}}_{DL \_ PIM} = {T}_{λ} ( {R}_{UL \_ PIM}^{T} ) \qquad ( 4 )$$

where (·)^{T} is the transpose operator without complex-conjugate and T_{λ}(·) is an electrical transform that is based on either a multi-dimensional spatial Discrete Fourier Transforms (DFT) or based on other methods.

It has been recognized that impairments created by mutual coupling and other antenna imperfections can cause significant antenna response variations between the uplink and the downlink bands in FDD systems with wide duplex gaps. Since the nulls are narrower than the beams, null-steering is much more sensitive to estimation errors than beam steering. Therefore, the impact of these analog impairments should be captured in order to perform the PIM downlink null steering in FDD systems. The system model is also redefined as shown in FIG. 2, where the H_{DL_PIM} matrix 8 is replaced by a black box 9.

To work around the frequency-dependent hardware impairments, a feedback-assisted PIM subspace acquisition method has been considered. This approach takes advantage of the fact that the W_{DL} downlink beamforming weights are known by the system. In addition, for each downlink set of precoding weights W_{DL}, the corresponding received uplink PIM power σ_{UL_PIM}² is measured in real-time through the PIM feedback path (see FIG. 2). Therefore, an estimate of the \hat{R}_{DL_PIM} downlink PIM covariance matrix can be computed as shown below:

$${\hat{R}}_{DL \_ PIM} = E [ {W}_{DL} \cdot ( {σ}_{UL \_ PIM}^{2} + α \cdot {σ}_{DL}^{2} ) \cdot {W}_{DL}^{H} ] \qquad ( 5 )$$

where:
E[·] is the expectation operator;
σ_{DL}² corresponds to the power of the current DL OFDM symbol; and
α is an arbitrary constant that is used to compensate for the UL-to-DL power difference.

A scaling factor is defined for each orthogonal frequency division multiplexed (OFDM) symbol. The scaling factor corresponds to the sum of the PIM power σ_{UL_PIM}² that it generated in the uplink, plus an adjusted version of the DL OFDM symbol power α·σ_{DL}². The factor α is used to compensate for the UL-to-DL power difference.

Some approaches enable the estimation of the downlink PIM eigenvectors in the presence of frequency-dependent hardware impairments in FDD systems with large duplex gaps. However, at least some of these algorithms lack a tracking mechanism which results in the following awkward algorithm implementation:
Detect the presence of PIM and identify the downlink PIM subspace; and
Steer nulls at the PIM sources.
   An open question is how to update the null steering weights or adapt to changes in non-stationary environments, to improve PIM reduction by null steering and adapt to changing PIM.

### SUMMARY

Some embodiments may advantageously provide a method and system for implementing iterative downlink passive intermodulation (PIM) spatial avoidance algorithms. Some embodiments provide at least one of the following features:
Some embodiments include an iterative solution with a built-in blind PIM downlink subspace tracking feature for operation in non-stationary environments;
The feedback path which monitors the uplink power can come from any victim channel and also from any radio equipment at a cellular site. This enables cooperative solutions between radios;
All radios at a given cellular site may benefit from the null steering. In many cases, applying the null steering in only one downlink carrier results in significant PIM improvement in multiple uplink channels from many radios;
Some algorithms may be scalable and configured to support multiple deployment scenarios (i.e., band combinations, different number of antennas, etc.);
Some algorithms may be compatible with codebook (LTE, NR Type-I/Type-II) based systems;
The nulling rank may be controlled by an input parameter to the algorithm; and/or
Some methods can work around antenna calibration errors.

According to one aspect, a method for reducing passive intermodulation, PIM, in a wireless transceiver from a preexisting extent of PIM is provided. The method includes: determining an uplink signal power; determining an estimate of a downlink PIM subspace that minimizes a cost function that depends on the uplink signal power and a previous estimate of the downlink PIM subspace; and applying a correction to a downlink antenna signal to reduce the PIM, the correction being based at least in part on the estimate of the downlink PIM subspace.

According to this aspect, in some embodiments, the cost function includes subtracting from an antenna signal vector a signal contribution which lies in a downlink PIM subspace, the signal contribution being determined by a product of the antenna signal vector and an estimate of a downlink PIM subspace projection matrix. In some embodiments, the estimate of the downlink PIM subspace projection matrix is generated by a product of the estimate of the downlink PIM subspace and a Hermitian transpose of the previous estimate of the downlink PIM subspace. In some embodiments, the cost function is minimized by application of a gradient descent algorithm with an update term that includes a gradient determined using the previous estimate of the downlink PIM subspace weighted by a step factor. In some embodiments, the cost function is minimized by application of a recursive least squares algorithm which is based at least in part on setting an approximate second order cost function gradient to zero. In some embodiments, an approximate second order cost function is minimized by application of an inverse QR-recursive least squares algorithm which is based at least in part on a product of an antenna signal vector and the previous estimate of the downlink PIM subspace. In some embodiments, an approximate second order cost function is minimized by application by an inverse QR-recursive least squares algorithm which is based at least in part on a pre-array including a term inversely proportional to a root mean square value of the uplink signal. In some embodiments, an approximate second order cost function is minimized by application of a block inverse QR-recursive least squares algorithm which is based at least in part on processing multiple samples concurrently to obtain pre-array blocks including a term inversely proportional to a root mean square of the uplink signal for the multiple samples.

According to another aspect, a wireless transceiver configured to reduce passive intermodulation, PIM, from a preexisting extent of PIM is provided. The wireless transceiver includes processing circuitry configured to: determine an uplink signal power; determine an estimate of a downlink PIM subspace that minimizes a cost function that depends on the uplink signal power and a previous estimate of the downlink PIM subspace; and apply a correction to a downlink antenna signal to reduce the PIM, the correction being based at least in part on the estimate of the downlink PIM subspace.

According to this aspect, in some embodiments, the cost function includes subtracting from an antenna signal vector a signal contribution which lies in a downlink PIM subspace, the signal contribution being determined by a product of the antenna signal vector and an estimate of a downlink PIM subspace projection matrix. In some embodiments, the estimate of the downlink PIM subspace projection matrix is generated by a product of the estimate of the downlink PIM subspace and a Hermitian transpose of the previous estimate of the downlink PIM subspace. In some embodiments, the cost function is minimized by application of a gradient descent algorithm with an update term that includes a gradient determined using the previous estimate of the downlink PIM subspace weighted by a step factor. In some embodiments, the cost function is minimized by application of a recursive least squares algorithm which is based at least in part on setting an approximate second order cost function gradient to zero. In some embodiments, an approximate second order cost function is minimized by application of an inverse QR-recursive least squares algorithm which is based at least in part on a product of an antenna signal vector and the previous estimate of the downlink PIM subspace. In some embodiments, an approximate second order cost function is minimized by application by an inverse QR-recursive least squares algorithm which is based at least in part on a pre-array including a term inversely proportional to a root mean square value of the uplink signal. In some embodiments, an approximate second order cost function is minimized by application of a block inverse QR-recursive least squares algorithm which is based at least in part on processing multiple samples concurrently to obtain pre-array blocks including a term inversely proportional to a root mean square of the uplink signal for the multiple samples.

According to yet another aspect, a network node is configured to reduce passive intermodulation, PIM, from a preexisting extent of PIM affecting performance of at least one wireless transceiver of the network node. The network node includes: at least one wireless transceiver configured to: receive an uplink signal vector at a first frequency; and transmit a downlink signal vector at a second frequency. The network node also includes processing circuitry in communication with the at least one wireless transceiver, the processing circuitry configured to: determine an uplink signal power based on the uplink signal vector; determine an estimate of a downlink PIM subspace that minimizes a function of: the downlink signal vector, a previous estimate of the downlink PIM subspace and the uplink signal power; and apply a correction to a downlink antenna signal to obtain the downlink signal vector, the downlink signal vector resulting in PIM that is less than a preexisting extent of PIM, the correction being based at least in part on the estimate of the downlink PIM subspace.

According to this aspect, in some embodiments, determining the estimate of the downlink PIM subspace includes estimating a PIM channel covariance matrix, the estimated PIM channel covariance matrix being based at least in part on a preselected number of eigenvectors. In some embodiments, the estimated PIM channel covariance matrix is based at least in part on a diagonal matrix of eigenvalues of the PIM channel covariance matrix. In some embodiments, the at least one wireless transceiver includes a first wireless transceiver configured to receive the uplink signal vector and a second wireless transceiver configured to transmit the downlink signal vector.

According to another aspect, a method in a network node configured to reduce passive intermodulation, PIM, from a preexisting extent of PIM affecting performance of at least one wireless transceiver of the network node is provided. The method includes: receiving an uplink signal vector at a first frequency; and transmitting a downlink signal vector at a second frequency. The method also includes determining an uplink signal power based on the uplink signal vector; determining an estimate of a downlink PIM subspace that minimizes a function of: the downlink signal vector, a previous estimate of the downlink PIM subspace and the uplink signal power; and applying a correction to a downlink antenna signal to obtain the downlink signal vector, the downlink signal vector resulting in PIM that is less than a preexisting extent of PIM, the correction being based at least in part on the estimate of the downlink PIM subspace.

According to this aspect, in some embodiments, determining the estimate of the downlink PIM subspace includes estimating a PIM channel covariance matrix, the estimated PIM channel covariance matrix being based at least in part on a preselected number of eigenvectors. In some embodiments, the estimated PIM channel covariance matrix is based at least in part on a diagonal matrix of eigenvalues of the PIM channel covariance matrix. In some embodiments, the at least one wireless transceiver includes a first wireless transceiver configured to receive the uplink signal vector and a second wireless transceiver configured to transmit the downlink signal vector.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an FDD system model of a network node and PIM sources;

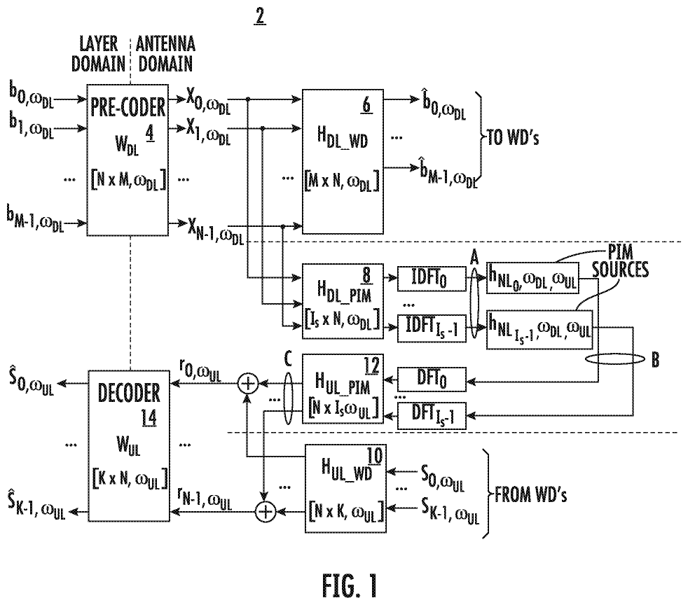

FIG. 2 is an FDD system model showing a PIM feedback path;

FIG. 3 is a schematic diagram of an example network architecture illustrating a communication system according to principles disclosed herein;

FIG. 4 is a block diagram of a network node in communication with a wireless device over a wireless connection according to some embodiments of the present disclosure;

FIG. 5 is a flowchart of an example process in a network node that implements iterative downlink passive intermodulation (PIM) spatial avoidance algorithms; and

FIG. 6 is a flowchart of an example process in a network node that implements iterative downlink passive intermodulation (PIM) spatial avoidance algorithms; and

FIG. 7 is a block diagram of a network node that implements an iterative downlink PIM spatial avoidance algorithm.

### DETAILED DESCRIPTION

Before describing in detail example embodiments, it is noted that the embodiments reside primarily in combinations of apparatus components and processing steps related to implementing iterative downlink passive intermodulation (PIM) spatial avoidance algorithms. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to iterative downlink passive intermodulation (PIM) spatial avoidance algorithms.

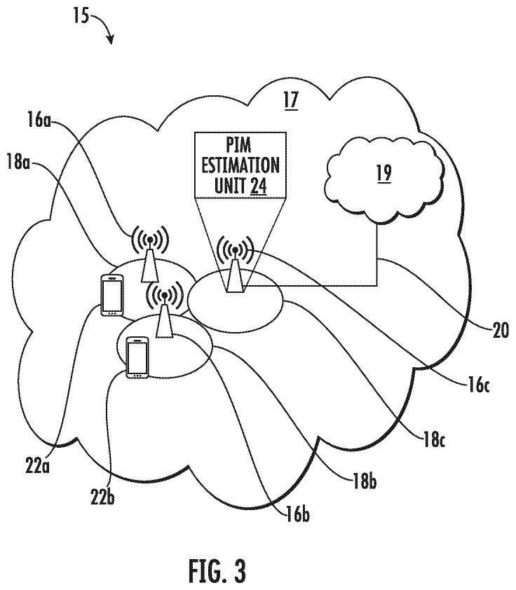

Returning again to the drawing figures, in which like elements are referred to by like reference numerals, there is shown in FIG. 3 a schematic diagram of a communication system 15, according to an embodiment, such as a 3GPP-type cellular network that may support standards such as LTE and/or NR (5G), which comprises an access network 17, such as a radio access network, and a core network 19. The access network 17 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 19 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (eNB or gNB) is configured to include a PIM estimation unit 24 which is configured to determine an estimate of a downlink PIM subspace that minimizes a function of: the downlink signal vector, a previous estimate of the downlink PIM subspace and the uplink signal power.

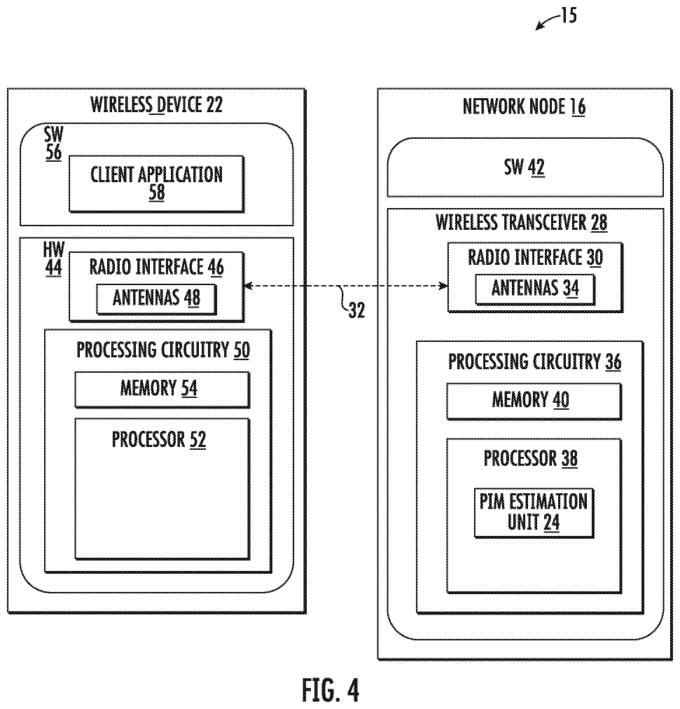

Example implementations, in accordance with an embodiment, of the WD 22 and network node 16 discussed in the preceding paragraphs will now be described with reference to FIG. 4.

The communication system 15 includes a network node 16 provided in a communication system 15 and including at least one wireless transceiver 28 enabling it to communicate with the WD 22. The at least one wireless transceiver 28 may include one or more radio interfaces 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. Each radio interface 30 includes an array of antennas 34 to radiate and receive signal(s) carrying electromagnetic waves.

In the embodiment shown, the at least one wireless transceiver 28 of the network node 16 further includes processing circuitry 36. The processing circuitry 36 may include a processor 38 and a memory 40. In some embodiments, multiple processors 38 may be included, each processor 38 being associated with a different one of the radio interfaces 30. In particular, in addition to or instead of a processor or processors, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processing circuit may be distributed such that different processing circuitry cores are associated with different radio interfaces 30. When the processing circuitry core is implemented by a processor 38, the processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a PIM estimation unit 24 which is configured to determine an estimate of a downlink PIM subspace that minimizes a function of: the downlink signal vector, a previous estimate of the downlink PIM subspace and the uplink signal power.

The communication system 15 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes one or more antenna 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22.

In some embodiments, the inner workings of the network node 16 and WD 22 may be as shown in FIG. 4 and independently, the surrounding network topology may be that of FIG. 3.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 3 and 4 show various “units” such as the PIM estimation unit 24 as being within a respective processor, it is contemplated that these units may be implemented such that a portion of the unit is stored in a corresponding memory within the processing circuitry. In other words, the units may be implemented in hardware or in a combination of hardware and software within the processing circuitry.

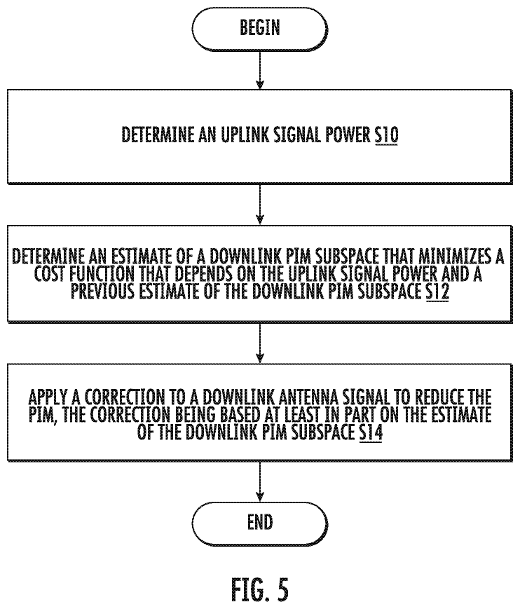

FIG. 5 is a flowchart of an example process in a wireless transceiver 28 for implementing iterative downlink passive intermodulation (PIM) spatial avoidance algorithms. One or more blocks described herein may be performed by one or more elements of the wireless transceiver 28 such as by one or more of processing circuitry 36 (including the PIM estimator unit 24), processor 38, and/or radio interface 30. Network node 16 such as via processing circuitry 36 and/or processor 38 and/or radio interface 30 is configured to determine an uplink signal power (Block S10). The process also includes determining an estimate of a downlink PIM subspace that minimizes a cost function that depends on the uplink signal power and a previous estimate of the downlink PIM subspace (Block S12). The process also includes applying a correction to a downlink antenna signal to reduce the PIM, the correction being based at least in part on the estimate of the downlink PIM subspace (Block S14).

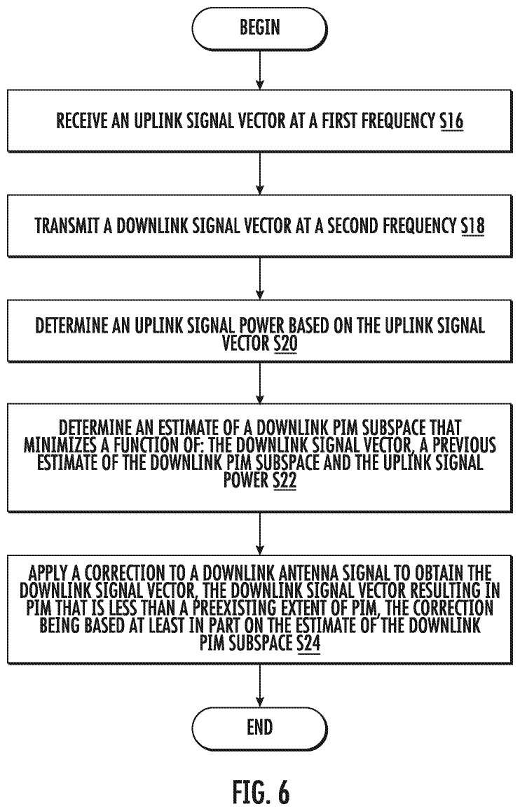

FIG. 6 is a flowchart of an example process in a network node 16 for implementing iterative downlink passive intermodulation (PIM) spatial avoidance algorithms. One or more blocks described herein may be performed by one or more elements of network node 16 such as by one or more of processing circuitry 36 (including the PIM estimator unit 24), processor 38, and/or radio interface 30. Network node 16 such as via processing circuitry 36 and/or processor 38 and/or radio interface 30 is configured to receive an uplink signal vector at a first frequency (Block S16) and transmit a downlink signal vector at a second frequency (Block S18). The process also includes determining an uplink signal power based on the uplink signal vector (Block S20). The process further includes determining an estimate of a downlink PIM subspace that minimizes a function of: the downlink signal vector, a previous estimate of the downlink PIM subspace and the uplink signal power (Block S22). The process also includes applying a correction to a downlink antenna signal to obtain the downlink signal vector, the downlink signal vector resulting in PIM that is less than a preexisting extent of PIM, the correction being based at least in part on the estimate of the downlink PIM subspace (Block S24).

Having described the general process flow of arrangements of the disclosure and having provided examples of hardware and software arrangements for implementing the processes and functions of the disclosure, the sections below provide details and examples of arrangements for implementing iterative downlink passive intermodulation (PIM) spatial avoidance algorithms.

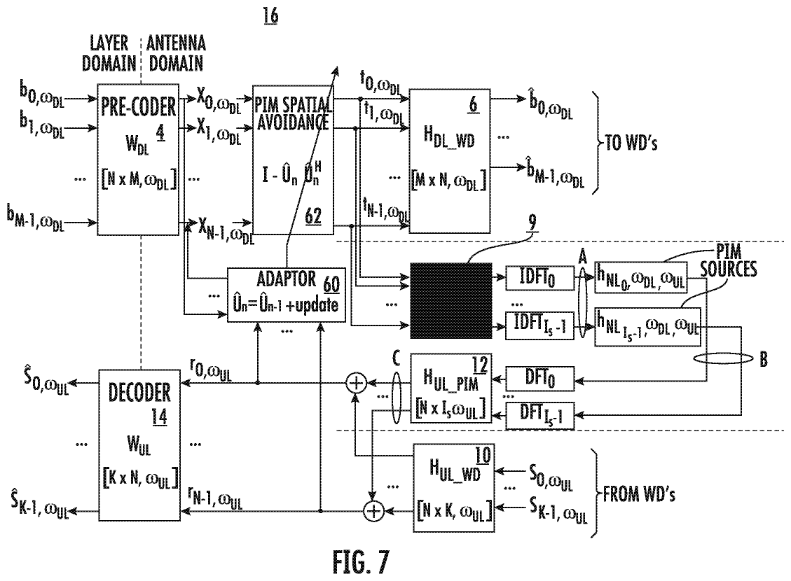

An iterative downlink PIM spatial avoidance algorithm is derived for Case 2 using the system model of the network node 16 that is shown in the example of FIG. 7 The precoder 4, the downlink channel matrix 6, the uplink channel matrix 10 and decoder 14 may be implemented by the radio interface 30 and/or processing circuitry 36. Also, an adaptor 60 and PIM correction unit 62 may also be implemented by the radio interface 30 and/or processing circuitry 36. The adaptor 60 may be configured to determine an estimate of a downlink PIM subspace. The PIM correction unit 62 may be configured to apply a correction to a downlink antenna signal to obtain a downlink signal vector, the correction being based at least in part on the estimate of the downlink PIM subspace.

An objective may include estimating a Ûϵ [symbol] ^{N×r} signal subspace which tracks the r dominant eigenvectors of the downlink PIM subspace U_{DL_PIM}. The second dimension of Û, i.e., the r variable, is the nulling rank to be addressed by the downlink PIM spatial avoidance algorithm. In most cases, r<Iₛ is chosen although it is possible to have r=Iₛ, where Iₛ the channel dimensions impacted by PIM.

At iteration n, the downlink transmitted vector t∈ [symbol] ^{N×1} may be generated by removing the signal contribution that lies in the estimated Ûₙ downlink PIM subspace as follows:

$$t = ( I - {\hat{U}}_{n} {\hat{U}}_{n}^{H} ) x = x - {\hat{U}}_{n} {\hat{U}}_{n}^{H} x \qquad ( 6 )$$

The corresponding uplink received vector rₙ∈ [symbol] ^{N×1} for iteration n may be written as:

$${r}_{n} = {r}_{UE , n} + {r}_{intercell , n} + {r}_{PIM , n} + {r}_{noise , n} \qquad ( 7 )$$

The uplink power σ_{UL,n}² can be written as the inner product of the uplink received vector rₙ:

$${σ}_{UL , n}^{2} = {r}_{n}^{H} {r}_{n} \qquad ( 8 )$$

The cost function used to minimize the uplink PIM power is defined as:

$${min}_{\hat{U}} E [ t \cdot {σ}_{UL}^{2} \cdot {t}^{H} ] \qquad ( 9 )$$

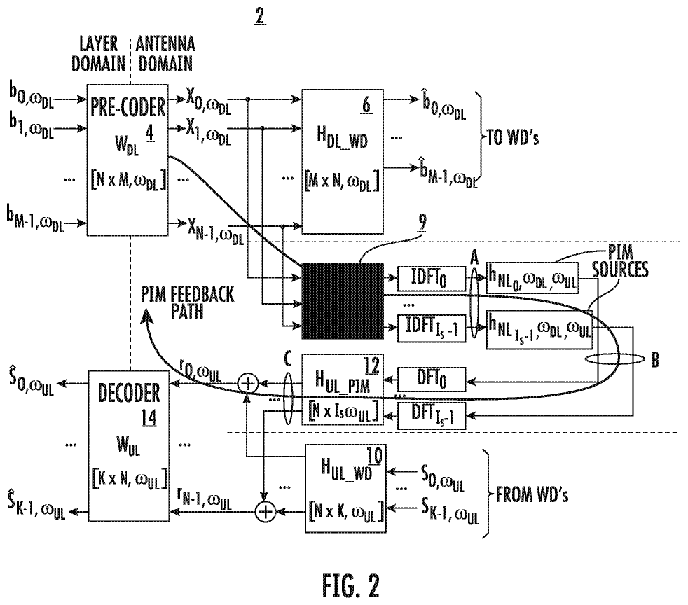

This cost function does not attempt to minimize the received PIM contribution r_{PIM} directly. Rather, in some embodiments, a downlink signal contribution which lies in the Û subspace is identified and removed such that the total uplink power σ_{UL}² is minimized. In some embodiments, an algorithm will identify the relationship between the downlink PIM subspace and the uplink power through the “PIM feedback path” shown in FIG. 2.

Substituting (6) and (8) into (9) yields:

$${min}_{\hat{U}} E [ ( x - {\hat{U}}_{n} {\hat{U}}_{n}^{H} x ) {r}^{H} {r ( x - {\hat{U}}_{n} {\hat{U}}_{n}^{H} x )}^{H} ] \qquad ( 10 )$$

### Gradient-Descent Algorithm

Equation (10) can be expanded to reveal a 4^{th} order cost function in terms of Û:

$$J ( \hat{U} ) = {xr}^{H} {rx}^{H} - {xr}^{H} {rx}^{H} {\hat{U}}_{n} {\hat{U}}_{n}^{H} - {\hat{U}}_{n} {\hat{U}}_{n}^{H} {xr}^{H} {rx}^{H} + {\hat{U}}_{n} {\hat{U}}_{n}^{H} {xr}^{H} {rx}^{H} {\hat{U}}_{n} {\hat{U}}_{n}^{H} \qquad ( 11 )$$

Equation (11) cannot be solved directly. Iterative gradient-based methods can be used to minimize the cost function. The gradient of equation (11) with respect to the Û* variable is:

$${∇}_{\hat{U} *} J ( \hat{U} ) = - 2 {xr}^{H} {rx}^{H} \hat{U} + \hat{U} {\hat{U}}^{H} {xr}^{H} {rx}^{H} \hat{U} \qquad ( 12 )$$

The weights can then be updated using the gradient-descent method, where μ is a suitable step-size:

$${\hat{U}}_{n} = {\hat{U}}_{n - 1} - μ {∇}_{\hat{U} *} J ( {\hat{U}}_{n - 1} ) \qquad ( 13 )$$

### Recursive Least-Squares (RLS) Algorithm

A “least-squares type” solution may be employed by finding an approximation that will help reduce the cost function order. To do so, the term ÛₙÛₙ^{H}x in equation (10) is replaced by ÛₙÛₙ₋₁^{H}x where Ûₙ₋₁ corresponds to the weights from the previous iteration. This concept, which is referred to as “projection approximation,” will enable us to derive a low implementation cost iterative least-squares solution.

An intermediate variable yϵ [symbol] ^{r×1} is introduced:

$$y = {\hat{U}}_{n - 1}^{H} x \qquad ( 14 )$$

Substituting (14) into (10):

$${min}_{\hat{U}} E [ ( x - \hat{U} y ) {r}^{H} {r ( x - \hat{U} y )}^{H} ] \qquad ( 15 )$$

Expanding (15) yields a second order cost function in terms of Û:

$$J ( \hat{U} ) = {xr}^{H} {rx}^{H} - \hat{U} {yr}^{H} {rx}^{H} - {xr}^{H} {ry}^{H} {\hat{U}}^{H} + \hat{U} {yr}^{H} {ry}^{H} {\hat{U}}^{H} \qquad ( 16 )$$

The gradient of (16) with respect to the Û*variable is:

$${∇}_{\hat{U} *} J ( \hat{U} ) = - {xr}^{H} {ry}^{H} + \hat{U} {yr}^{H} {ry}^{H} \qquad ( 17 )$$

Setting the gradient (17) to zero yields the following expression for the subspace Û:

$$\begin{matrix}{∇}_{\hat{U} *} J ( \hat{U} ) = 0 \\ ⇒ \hat{U} {yr}^{H} {ry}^{H} = {xr}^{H} {ry}^{H} \\ ⇒ \hat{U} = ( {xr}^{H} {ry}^{H} ) {( {yr}^{H} {ry}^{H} )}^{- 1}\end{matrix} \qquad ( 18 )$$

To simplify the notation, the following variable substitutions may be made:

$$Δ = {xr}^{H} {ry}^{H} \qquad ( 19 )$$

$$Π = {yr}^{H} {ry}^{H} \qquad ( 20 )$$

Substituting (19) and (20) into (18):

$$\hat{U} = Δ {Π}^{- 1} \qquad ( 21 )$$

The Δ and the Π matrices can be computed iteratively as follows:

$$\begin{matrix}{Δ}_{n} = {λΔ}_{n - 1} + {xr}^{H} {ry}^{H} \\ {Π}_{n} = {λΠ}_{n - 1} + {yr}^{H} {ry}^{H}\end{matrix} \qquad ( 22 )$$

where 0«λ≤1 is a forgetting factor which assigns a smaller weight to older data, thus putting more emphasis on the newer data such that the algorithm can track changes in non-stationary environments. This feature is referred to as “blind” downlink PIM subspace tracking since the Ûₙ subspace is only determined from the knowledge of the previous estimate Ûₙ₋₁, the downlink signal x and the uplink power r^{H}r that the previous transmission generated.

From (22), the Πₙ matrix inverse at iteration n can be written as:

$${Π}_{n}^{- 1} = {( {λΠ}_{n - 1} + {yr}^{H} {ry}^{H} )}^{- 1} \qquad ( 23 )$$

A variable substitution is made such that Πₙ⁻¹ is replaced by the Pₙ matrix:

$$\begin{matrix}{Π}_{n}^{- 1} = {P}_{n} \\ {Π}_{n - 1}^{- 1} = {P}_{n - 1}\end{matrix} \qquad ( 24 )$$

Substituting (24) into (23):

$${P}_{n} = {( {λΠ}_{n - 1} + {yr}^{H} {ry}^{H} )}^{- 1} \qquad ( 25 )$$

Equation (25) can be solved using the Woodbury matrix identity:

$${P}_{n} = {( A + B C D )}^{- 1} = {A}^{- 1} - {A}^{- 1} {B ( {C}^{- 1} + D {A}^{- 1} B )}^{- 1} D {A}^{- 1} \qquad ( 26 )$$

The following Woodbury variable identifications are made in equation (25):

$$A ← λ {\prod }_{n - 1} ⇒ {A}^{- 1} = {λ}^{- 1} {\prod }_{n - 1}^{- 1} ⇒ {A}^{- 1} = {λ}^{- 1} {P}_{n - 1}$$

B←y
C←r^{H}r, noting that C corresponds to a scalar value, i.e. the total instantaneous uplink power across all branches, with

$${C}^{- 1} = \frac{1}{{r}^{H} r} .$$

D←y^{H}

Solving (26) with the above variable substitutions yields:

$$\begin{matrix}{P}_{n} = {A}^{- 1} - {A}^{- 1} {B ( {C}^{- 1} + D {A}^{- 1} B )}^{- 1} D {A}^{- 1} \\ = {λ}^{- 1} {P}_{n - 1} - {λ}^{- 1} {P}_{n - 1} {y ( \frac{1}{{r}^{H} r} + {y}^{H} {λ}^{- 1} {P}_{n - 1} y )}^{- 1} {y}^{H} {λ}^{- 1} {P}_{n - 1} \\ = {λ}^{- 1} {P}_{n - 1} - \frac{{λ}^{- 1} {P}_{n - 1} y {y}^{H} {P}_{n - 1} {λ}^{- 1}}{\frac{1}{{r}^{H} r} + {λ}^{- 1} {y}^{H} {P}_{n - 1} y}\end{matrix} \qquad ( 27 )$$

Note that the dominator of the last term on the last line of (27) is a scalar value since y is a column vector of size r×1.

Equation (27) describes the mechanism for recursively updating the Pₙ matrix, which is the desired matrix inverse from Equation (25), i.e. (λΠₙ₋₁+yr^{H}y^{H})⁻¹.

Equations (22), (24) and (27) may now be used to rewrite (21) as follows:

$$\begin{matrix}{\hat{U}}_{n} = {Δ}_{n} {\prod }_{n}^{- 1} \\ = {Δ}_{n} {P}_{n} \\ = ( λ {Δ}_{n - 1} + x {r}^{H} r {y}^{H} ) ( {λ}^{- 1} {P}_{n - 1} - \frac{{λ}^{- 1} {P}_{n - 1} y {y}^{H} {P}_{n - 1} {λ}^{- 1}}{\frac{1}{{r}^{H} r} + {λ}^{- 1} {y}^{H} {P}_{n - 1} y} ) \\ = \begin{matrix}{Δ}_{n - 1} {P}_{n - 1} + {λ}^{- 1} x {r}^{H} r {y}^{H} {P}_{n - 1} - {Δ}_{n - 1} {P}_{n - 1} \frac{y {y}^{H} {P}_{n - 1} {λ}^{- 1}}{\frac{1}{{r}^{H} r} + {λ}^{- 1} {y}^{H} {P}_{n - 1} y} - \\ x {r}^{H} {ry}^{H} \frac{{λ}^{- 1} {P}_{n - 1} y {y}^{H} {P}_{n - 1} {λ}^{- 1}}{\frac{1}{{r}^{H} r} + {λ}^{- 1} {y}^{H} {P}_{n - 1} y}\end{matrix}\end{matrix} \qquad ( 28 )$$

Recognizing that the term Δₙ₋₁Pₙ₋₁ corresponds to Ûₙ₋₁ in equation (28), the variable substitution is made:

$$\begin{matrix}{\hat{U}}_{n} = \begin{matrix}{\hat{U}}_{n - 1} + {λ}^{- 1} x {r}^{H} r {y}^{H} {P}_{n - 1} - {\hat{U}}_{n - 1} \frac{y {y}^{H} {P}_{n - 1} {λ}^{- 1}}{\frac{1}{{r}^{H} r} + {λ}^{- 1} {y}^{H} {P}_{n - 1} y} - \\ {xr}^{H} r {y}^{H} \frac{{λ}^{- 1} {P}_{n - 1} y {y}^{H} {P}_{n - 1} {λ}^{- 1}}{\frac{1}{{r}^{H} r} + {λ}^{- 1} {y}^{H} {P}_{n - 1} y}\end{matrix} \\ = \begin{matrix}{\hat{U}}_{n - 1} - {\hat{U}}_{n - 1} \frac{y {y}^{H} {P}_{n - 1} {λ}^{- 1}}{\frac{1}{{r}^{H} r} + {λ}^{- 1} {y}^{H} {P}_{n - 1} y} + {λ}^{- 1} x {r}^{H} r {y}^{H} {P}_{n - 1} - \\ {xr}^{H} r \frac{{λ}^{- 1} {y}^{H} {P}_{n - 1} y}{\frac{1}{{r}^{H} r} + {λ}^{- 1} {y}^{H} {P}_{n - 1} y} {y}^{H} {P}_{n - 1} {λ}^{- 1}\end{matrix} \\ = \begin{matrix}{\hat{U}}_{n - 1} - {\hat{U}}_{n - 1} \frac{y {y}^{H} {P}_{n - 1} {λ}^{- 1}}{\frac{1}{{r}^{H} r} + {λ}^{- 1} {y}^{H} {P}_{n - 1} y} + {λ}^{- 1} x {r}^{H} r {y}^{H} {P}_{n - 1} - \\ {λ}^{- 1} x {r}^{H} r \frac{{λ}^{- 1} {y}^{H} {P}_{n - 1} y}{\frac{1}{{r}^{H} r} + {λ}^{- 1} {y}^{H} {P}_{n - 1} y} {y}^{H} {P}_{n - 1}\end{matrix} \\ = \begin{matrix}{\hat{U}}_{n - 1} - {\hat{U}}_{n - 1} \frac{y {y}^{H} {P}_{n - 1} {λ}^{- 1}}{\frac{1}{{r}^{H} r} + {λ}^{- 1} {y}^{H} {P}_{n - 1} y} + \\ {λ}^{- 1} x {r}^{H} r ( 1 - \frac{{λ}^{- 1} {y}^{H} {P}_{n - 1} y}{\frac{1}{{r}^{H} r} + {λ}^{- 1} {y}^{H} {P}_{n - 1} y} ) {y}^{H} {P}_{n - 1}\end{matrix} \\ = \begin{matrix}{\hat{U}}_{n - 1} - {\hat{U}}_{n - 1} \frac{y {y}^{H} {P}_{n - 1} {λ}^{- 1}}{\frac{1}{{r}^{H} r} + {λ}^{- 1} {y}^{H} {P}_{n - 1} y} + \\ {λ}^{- 1} x {r}^{H} r ( \frac{\frac{1}{{r}^{H} r} + {λ}^{- 1} {y}^{H} {P}_{n - 1} y - {λ}^{- 1} {y}^{H} {P}_{n - 1} y}{\frac{1}{{r}^{H} r} + {λ}^{- 1} {y}^{H} {P}_{n - 1} y} ) {y}^{H} {P}_{n - 1}\end{matrix} \\ = \begin{matrix}{\hat{U}}_{n - 1} - {U}_{n - 1} \frac{y {y}^{H} {P}_{n - 1} {λ}^{- 1}}{\frac{1}{{r}^{H} r} + {λ}^{- 1} {y}^{H} {P}_{n - 1} y} + \\ {λ}^{- 1} x {r}^{H} r ( \frac{\frac{1}{{r}^{H} r}}{\frac{1}{{r}^{H} r} + {λ}^{- 1} {y}^{H} {P}_{n - 1} y} ) {y}^{H} {P}_{n - 1}\end{matrix} \\ = {\hat{U}}_{n - 1} + \frac{x {r}^{H} r}{{r}^{H} r} \frac{{λ}^{- 1} {y}^{H} {P}_{n - 1}}{\frac{1}{{r}^{H} r} + {λ}^{- 1} {y}^{H} {P}_{n - 1} y} - {\hat{U}}_{n - 1} y \frac{{λ}^{- 1} {y}^{H} {P}_{n - 1}}{\frac{1}{{r}^{H} r} + {λ}^{- 1} {y}^{H} {P}_{n - 1} y} \\ = {\hat{U}}_{n - 1} + ( x - {\hat{U}}_{n - 1} y ) \frac{{λ}^{- 1} {y}^{H} {P}_{n - 1}}{\frac{1}{{r}^{H} r} + {λ}^{- 1} {y}^{H} {P}_{n - 1} y}\end{matrix} \qquad ( 29 )$$

After some simplifications, the Recursive Least-Squares (RLS) algorithm that is described on the last line of equation (29) results. The new weights Un at iteration n only depend on the Ûₙ₋₁ and the Pₙ₋₁ variables from the previous iteration, the precoded DL signal x (i.e. y=Ûₙ₋₁^{H}x) and the total instantaneous uplink power r^{H}r.

To simplify the notation, some intermediate variables are introduced:

$$\begin{matrix}{γ}_{n} = \frac{1}{\frac{1}{{r}^{H} r} + {λ}^{- 1} {y}^{H} {P}_{n - 1} y} \\ = \frac{1}{{σ}_{U L}^{- 2} + {λ}^{- 1} {y}^{H} {P}_{n - 1} y}\end{matrix} \qquad ( 30 )$$

$${g}_{n} = {λ}^{- 1} {y}^{H} {P}_{n - 1} {γ}_{n} \qquad ( 31 )$$

Using these two new variables, the RLS-based recursions from Equations (27) and (29) may now be written as:

$${P}_{n} = {λ}^{- 1} {P}_{n - 1} - \frac{{g}_{n}^{H} {g}_{n}}{{γ}_{n}} \qquad ( 32 )$$

$${\hat{U}}_{n} = {\hat{U}}_{n - 1} + ( x - {\hat{U}}_{n - 1} y ) {g}_{n} \qquad ( 33 )$$

The algorithm is initialized with the following variable assignments:

$${P}_{- 1} = \frac{1}{δ} I ϵ {r \times r}^{} \qquad ( 34 )$$

$${\hat{U}}_{- 1} = I ϵ {N \times r}^{} \qquad ( 35 )$$

The initial weights Û₋₁ cannot be set to the all-zero vector (or matrix depending on the PIM rank r) otherwise equation (33) never starts updating the weights.

Therefore, a few other initialization options can be considered:
1) By making an initial “educated guess”,
2) Utilizing pure random values,
3) Initializing the weights to the r leading columns of the
N×N identity matrix I. This may be the initialization and start of the weights from an orthonormal basis, which may be an end goal.

In equation (34), δ«1 is a small regularization factor which reflects a high degree of uncertainty in the Û₋₁ initial weight values.

It is well known that the Pₙ recursion (32) may become unstable over iterations, especially when working with fixed-point implementations. Indeed, the round-off and truncation errors may cause Pₙ to lose its Hermitian symmetry or positive-definiteness over time. Therefore, a more numerically reliable approach includes only computing the “square-roots” of Pₙ, gₙ and γₙ using matrix factorization methods such as Givens Rotations, Householder Reflections, the QR decomposition or the Cholesky factorization. This leads to various “QR-RLS”, “inverse QR-RLS”, “Extended QR-RLS” and other RLS variants.

The inverse QR-RLS algorithm provides the Un weights in a straightforward manner, i.e., one extra processing step may be required to obtain the weights values explicitly using the “QR-RLS” method. In addition, the Extended QR-RLS algorithm can also face numerical issues in fixed-point implementations. An inverse QR-RLS algorithm is derived as the approach is numerically robust and involves fewer processing steps. Similar derivations may be obtained for other RLS variants.

### Inverse OR-RLS Algorithm

The inverse QR-RLS algorithm is obtained by re-writing equations (30) and (31) as follows:

$${γ}_{n}^{- 1} = {σ}_{U L}^{- 2} + {λ}^{- 1} {y}^{H} {P}_{n - 1} y \qquad ( 36 )$$

$${g}_{n} {γ}_{n}^{- 1} = {λ}^{- 1} {y}^{H} {P}_{n - 1} \qquad ( 37 )$$

The combined system of equations (36) and (37) is similar to the one below where the C and F variables are identified from the knowledge of A, B, D, E:

$$C {C}^{*} = A {A}^{*} + B {B}^{*} \qquad ( 38 )$$

$$F {C}^{*} = D {A}^{*} + E {B}^{*} \qquad ( 39 )$$

Equations (38) and (39) can be thought of as “template equations” with scalar variables where the * operator represents the complex conjugate. Some variables may be vector or matrix quantities. Therefore, the * operator would be replaced by the Hermitian transpose operator {·}^{H}.

Systems of equations like that of (38) and (39) may be solved by:
1) Creating a pre-array [symbol] as follows by making proper variable identifications:

$$= [ \begin{matrix}A & B \\ D & E\end{matrix} ] \qquad ( 40 )$$

2) Reducing the [symbol] pre-array via a unitary transform θ, which may or may not be explicitly known, in order to obtain a lower triangular [symbol] post-array on the right-hand side:

$$θ = \qquad ( 41 )$$

$$where = [ \begin{matrix}X & 0 \\ Y & Z\end{matrix} ] \qquad ( 42 )$$

Before proceeding to the variable identification, (37) is rewritten by complex conjugating both sides of the equation:

$${γ}_{n}^{- *} {g}_{n}^{H} = {λ}^{- 1} {P}_{n - 1}^{H} y ⇒ {g}_{n}^{H} {γ}_{n}^{- 1} = {λ}^{- 1} {P}_{n - 1} y \qquad ( 43 )$$

The Pₙ₋₁ Hermitian symmetry enables transition from the first to the second line on the right-hand side of (43). Similarly, the γₙ⁻* scalar quantity may be applied from the left or from the right on the left hand-side of (43).

$$C ← {γ}_{n}^{- 1 / 2} A ← {σ}_{U L}^{- 1} B ← {λ}^{- 1 / 2} {y}^{H} {P}_{n - 1}^{1 / 2} F ← {g}_{n}^{H} {γ}_{n}^{- 1 / 2} D ← 0 E ← {λ}^{- 1 / 2} {P}_{n - 1}^{1 / 2} \qquad ( 44 )$$

Starting with (36), both sides of the equation can be written as vector inner products:

$${CC}^{*} = {AA}^{*} + {BB}^{*} \qquad ( 45 )$$

$$⇒ [ \begin{matrix}{γ}_{n}^{- 1 / 2} & 0\end{matrix} ] \cdot [ \begin{matrix}{γ}_{n}^{- 1 / 2} \\ 0\end{matrix} ] = [ \begin{matrix}{σ}_{UL}^{- 1} & {λ}^{- 1 / 2} {y}^{H} {P}_{n - 1}^{1 / 2}\end{matrix} ] \cdot [ \begin{matrix}{σ}_{UL}^{- 1} \\ {λ}^{- 1 / 2} {P}_{n - 1}^{* / 2} y\end{matrix} ]$$

Equation (43) can also be written in terms of vector inner products:

$${FC}^{*} = {DA}^{*} + {EB}^{*} \qquad ( 46 )$$

$$⇒ [ \begin{matrix}{g}_{n}^{H} {γ}_{n}^{- 1 / 2} & z\end{matrix} ] \cdot [ \begin{matrix}{γ}_{n}^{- 1 / 2} \\ 0\end{matrix} ] = [ \begin{matrix}0 & {λ}^{- 1 / 2} {P}_{n - 1}^{1 / 2}\end{matrix} ] [ \begin{matrix}{σ}_{UL}^{- 1} \\ {λ}^{- 1 / 2} {P}_{n - 1}^{* / 2} y\end{matrix} ]$$

From the variable identifications (44), the [symbol] pre-array is explicitly populated as follows:

$$= [ \begin{matrix}{σ}_{UL}^{- 1} & {λ}^{- 1 / 2} {y}^{H} {P}_{n - 1}^{1 / 2} \\ 0 & {λ}^{- 1 / 2} {P}_{n - 1}^{1 / 2}\end{matrix} ] \qquad ( 47 )$$

“Squaring” both sides of equation (41) would then yield:

$$[ \begin{matrix}A & B \\ D & E\end{matrix} ] {{θθ}^{H} [ \begin{matrix}A & B \\ D & E\end{matrix} ]}^{H} = {[ \begin{matrix}X & 0 \\ Y & Z\end{matrix} ] [ \begin{matrix}X & 0 \\ Y & Z\end{matrix} ]}^{H} \qquad ( 48 )$$

Since θ is a unitary matrix, the product θθ^{H}=I. Therefore, equation (48) is reduced to:

$$[ \begin{matrix}A & B \\ D & E\end{matrix} ] [ \begin{matrix}{A}^{*} & {D}^{*} \\ {B}^{*} & {E}^{*}\end{matrix} ] = [ \begin{matrix}X & 0 \\ Y & Z\end{matrix} ] [ \begin{matrix}{X}^{*} & {Y}^{*} \\ 0 & {Z}^{*}\end{matrix} ] \qquad ( 49 )$$

Now introducing the variables identified in (44):

$$[ \begin{matrix}{σ}_{UL}^{- 1} & {λ}^{- 1 / 2} {y}^{H} {P}_{n - 1}^{1 / 2} \\ 0 & {λ}^{- 1 / 2} {P}_{n - 1}^{1 / 2}\end{matrix} ] [ \begin{matrix}{σ}_{UL}^{- 1} & 0 \\ {λ}^{- 1 / 2} {P}_{n - 1}^{* / 2} y & {λ}^{- 1 / 2} {P}_{n - 1}^{* / 2}\end{matrix} ] = [ \begin{matrix}X & 0 \\ Y & Z\end{matrix} ] [ \begin{matrix}{X}^{*} & {Y}^{*} \\ 0 & {Z}^{*}\end{matrix} ] \qquad ( 50 )$$

$$⇒ [ \begin{matrix}{σ}_{UL}^{- 2} + {λ}^{- 1} {y}^{H} {P}_{n - 1} y & {λ}^{- 1} {y}^{H} {P}_{n - 1} \\ {λ}^{- 1} {P}_{n - 1} y & {λ}^{- 1} {P}_{n - 1}\end{matrix} ] = [ \begin{matrix}{XX}^{*} & {XY}^{*} \\ {YX}^{*} & {YY}^{*} + {ZZ}^{*}\end{matrix} ]$$

Computing the various inner products in (50) leaves three relationships:

$${XX}^{*} = {σ}_{UL}^{- 2} + {λ}^{- 1} {y}^{H} {P}_{n - 1} y \qquad ( 51 )$$

$${YX}^{*} = {λ}^{- 1} {P}_{n - 1} y \qquad ( 52 )$$

$${YY}^{*} + {ZZ}^{*} = {λ}^{- 1} {P}_{n - 1} \qquad ( 53 )$$

From (36) and (51), the following identifications are made:

$${XX}^{*} = {γ}_{n}^{- 1} \qquad ( 54 )$$

$$⇒ X = {γ}_{n}^{- 1 / 2}$$

From (43), (52) and (54) the following identifications are made:

$${YX}^{*} = {λ}^{- 1} {P}_{n - 1} y \qquad ( 55 )$$

$$⇒ Y {γ}_{n}^{- 1 / 2} = {λ}^{- 1} {P}_{n - 1} y$$

$$⇒ Y {γ}_{n}^{- 1 / 2} = {g}_{n}^{H} {γ}_{n}^{- 1}$$

$$⇒ Y = {g}_{n}^{H} {γ}_{n}^{- 1 / 2}$$

From (32), (53) and (55) the following Z value may be extracted:

$${YY}^{*} + {ZZ}^{*} = {λ}^{- 1} {P}_{n - 1} \qquad ( 56 )$$

$$⇒ {g}_{n}^{H} {γ}_{n}^{- 1} {g}_{n} + {ZZ}^{*} = {λ}^{- 1} {P}_{n - 1}$$

$$⇒ {ZZ}^{*} = {λ}^{- 1} {P}_{n - 1} - \frac{{g}_{n}^{H} {g}_{n}}{{γ}_{n}}$$

$$⇒ {ZZ}^{*} = {P}_{n}$$

$$⇒ Z = {P}_{n}^{1 / 2}$$

In summary, by factorizing the [symbol] pre-array into a lower triangular [symbol] post-array, the variables from the right-hand side of (57) are obtained:

$$θ = \qquad ( 57 )$$

$$⇒ [ \begin{matrix}{σ}_{UL}^{- 1} & {λ}^{- 1 / 2} {y}^{H} {P}_{n - 1}^{1 / 2} \\ 0 & {λ}^{- 1 / 2} {P}_{n - 1}^{1 / 2}\end{matrix} ] θ = [ \begin{matrix}{γ}_{n}^{- 1 / 2} & 0 \\ {g}_{n}^{H} {γ}_{n}^{- 1 / 2} & {P}_{n}^{1 / 2}\end{matrix} ]$$

As mentioned before, the unitary θ matrix does not need to be explicitly known only the final result on the right-hand side of (57) may be needed; other matrix factorization methods that reduces [symbol] into a lower triangular matrix may work.

The left-hand side of (57) only depends on the value from the previous iteration Pₙ₋₁^{1/2}, y^{H}(=x^{H}Uₙ₋₁) as well as the uplink power—and implicitly the PIM power—that was generated by the previous set of weights Uₙ₋₁.

The Pₙ^{1/2} matrix that is generated at any given iteration may directly be injected into the [symbol] pre-array for the next iteration.

The weight updating equation (33) is re-written using the output variables from (57):

$${\hat{U}}_{n} = {\hat{U}}_{n - 1} + ( x - {\hat{U}}_{n - 1} y ) {( {γ}_{n}^{- 1 / 2} )}^{- 1} {( {g}_{n}^{H} {γ}_{n}^{- 1 / 2} )}^{H} \qquad ( 58 )$$

The inverse QR-RLS downlink PIM spatial avoidance algorithm for Case 2 is summarized as follows in Table I.

TABLE I

```
Algorithm Inverse QR-RLS DL PIM Spatial Avoidance
  1: Choose 0 << λ ≤ 1 and 0 < δ << 1
  2: Û₋₁ ← I ∈ [symbol]  ^{N×r}
  3:  ${P}_{- 1}^{1 / 2} ← \frac{1}{\sqrt{δ}} I ∈ {r \times r}^{}$
  4: for n = 0, 1, 2, ... do
  5: y = Ûₙ₋₁^{H} x
  6: Transmit t = x − Û₋₁y
  7:  $Receive r and compute {σ}_{UL}^{- 1} = \frac{1}{\sqrt{{}_{r} {H}_{r}}}$
  8:  $Form the pre - array = [ \begin{matrix}{σ}_{UL}^{- 1} & {λ}^{\frac{- 1}{2}} {y}^{H} {P}_{n - 1}^{\frac{1}{2}} \\ 0 & {λ}^{\frac{- 1}{2}} {P}_{n - 1}^{\frac{1}{2}}\end{matrix} ]$
  9:  $Compute the post - array = [ \begin{matrix}{γ}_{n}^{\frac{- 1}{2}} & 0 \\ {g}_{n}^{H} {γ}_{n}^{\frac{- 1}{2}} & {P}_{n}^{\frac{1}{2}}\end{matrix} ]$
10:  ${\hat{U}}_{n} = {\hat{U}}_{n - 1} + {t ( {γ}^{\frac{- 1}{2}} )}^{- 1} {( {g}_{n}^{H} {γ}^{\frac{- 1}{2}} )}^{H}$
11: end for
```

### Block Inverse OR-RLS Algorithm

In an alternative embodiment, the inverse QR-RLS algorithm processes multiple samples concurrently as opposed to one sample per iteration. In this case, the algorithm may be referred to as the “block inverse QR-RLS algorithm” since it operates on blocks of data. The pre-array [symbol] is formed using the procedure that was described previously, but with different variable dimensions as shown below:

$$ = [ \begin{matrix}{{σ}_{UL}^{- 1}}_{[ {N}_{samp} \times {N}_{samp} ]} & {λ}^{- 1 / 2} {y}^{H} {P}_{n - {1}_{[ {N}_{samp} \times r ]}}^{1 / 2} \\ {0}_{[ r \times {N}_{samp} ]} & {λ}^{- 1 / 2} {P}_{n - {1}_{[ r \times r ]}}^{1 / 2}\end{matrix} ] \qquad ( 59 )$$

where Nₛₐₘₚ is the number of samples in one block.

The [symbol] post-array for the block inverse QR-RLS algorithm follows the same structure as that of the sample-based version, but with different variable dimensions as shown below:

$$= [ \begin{matrix}{{γ}_{n}^{- 1 / 2}}_{[ {N}_{samp} \times {N}_{samp} ]} & {0}_{[ {N}_{samp} \times r ]} \\ {g}_{n}^{H} {{γ}_{n}^{- 1 / 2}}_{[ r \times {N}_{samp} ]} & {{P}_{n}^{1 / 2}}_{[ r \times r ]}\end{matrix} ] \qquad ( 60 )$$

### Alternative Embodiment

For both the sample-based and the block-based versions of the inverse QR-RLS algorithm, it is also possible to apply a Hermitian transpose operation to the pre-array [symbol] such that the matrix factorization yields an upper triangular post-array [symbol] . In this situation, equations (57) and (58) may be re-written as:

$$θ = \qquad ( 61 )$$

$$⇒ [ \begin{matrix}{σ}_{UL}^{- 1} & 0 \\ {λ}^{- 1 / 2} {P}_{n - 1}^{* / 2} y & {λ}^{- 1 / 2} {P}_{n - 1}^{* / 2}\end{matrix} ] θ = [ \begin{matrix}{γ}_{n}^{- 1 / 2} & {g}_{n} {γ}_{n}^{- 1 / 2} \\ 0 & {P}_{n}^{* / 2}\end{matrix} ]$$

$${\hat{U}}_{n} = {\hat{U}}_{n - 1} + ( x - {\hat{U}}_{n - 1} y ) {( {γ}_{n}^{- 1 / 2} )}^{- 1} ( {g}_{n} {γ}_{n}^{- 1 / 2} ) \qquad ( 62 )$$

The iterative downlink PIM spatial avoidance algorithms that are described in above may be implemented in the cloud or in edge computing resources.

Thus, a fully iterative and rank-controlled algorithm is derived to steer downlink nulls at external PIM sources. The algorithm has a built-in blind downlink PIM subspace tracking feature such that the null-steering weights can be adapted in non-stationary environments.

According to one aspect, a method for reducing passive intermodulation, PIM, in a wireless transceiver 28 from a preexisting extent of PIM is provided. The method includes: determining an uplink signal power; determining an estimate of a downlink PIM subspace that minimizes a cost function that depends on the uplink signal power and a previous estimate of the downlink PIM subspace; and applying a correction to a downlink antenna signal to reduce the PIM, the correction being based at least in part on the estimate of the downlink PIM subspace.

According to this aspect, in some embodiments, the cost function includes subtracting from an antenna signal vector a signal contribution which lies in a downlink PIM subspace, the signal contribution being determined by a product of the antenna signal vector and an estimate of a downlink PIM subspace projection matrix. In some embodiments, the estimate of the downlink PIM subspace projection matrix is generated by a product of the estimate of the downlink PIM subspace and a Hermitian transpose of the previous estimate of the downlink PIM subspace. In some embodiments, the cost function is minimized by application of a gradient descent algorithm with an update term that includes a gradient determined using the previous estimate of the downlink PIM subspace weighted by a step factor. In some embodiments, the cost function is minimized by application of a recursive least squares algorithm which is based at least in part on setting an approximate second order cost function gradient to zero. In some embodiments, an approximate second order cost function is minimized by application of an inverse QR-recursive least squares algorithm which is based at least in part on a product of an antenna signal vector and the previous estimate of the downlink PIM subspace. In some embodiments, an approximate second order cost function is minimized by application by an inverse QR-recursive least squares algorithm which is based at least in part on a pre-array including a term inversely proportional to a root mean square value of the uplink signal. In some embodiments, an approximate second order cost function is minimized by application of a block inverse QR-recursive least squares algorithm which is based at least in part on processing multiple samples concurrently to obtain pre-array blocks including a term inversely proportional to a root mean square of the uplink signal for the multiple samples.

According to another aspect, a wireless transceiver 28 configured to reduce passive intermodulation, PIM, from a preexisting extent of PIM is provided. The wireless transceiver 28 includes processing circuitry 36 configured to: determine an uplink signal power; determine an estimate of a downlink PIM subspace that minimizes a cost function that depends on the uplink signal power and a previous estimate of the downlink PIM subspace; and apply a correction to a downlink antenna signal to reduce the PIM, the correction being based at least in part on the estimate of the downlink PIM subspace.

According to this aspect, in some embodiments, the cost function includes subtracting from an antenna signal vector a signal contribution which lies in a downlink PIM subspace, the signal contribution being determined by a product of the antenna signal vector and an estimate of a downlink PIM subspace projection matrix. In some embodiments, the estimate of the downlink PIM subspace projection matrix is generated by a product of the estimate of the downlink PIM subspace and a Hermitian transpose of the previous estimate of the downlink PIM subspace. In some embodiments, the cost function is minimized by application of a gradient descent algorithm with an update term that includes a gradient determined using the previous estimate of the downlink PIM subspace weighted by a step factor. In some embodiments, the cost function is minimized by application of a recursive least squares algorithm which is based at least in part on setting an approximate second order cost function gradient to zero. In some embodiments, an approximate second order cost function is minimized by application of an inverse QR-recursive least squares algorithm which is based at least in part on a product of an antenna signal vector and the previous estimate of the downlink PIM subspace. In some embodiments, an approximate second order cost function is minimized by application by an inverse QR-recursive least squares algorithm which is based at least in part on a pre-array including a term inversely proportional to a root mean square value of the uplink signal. In some embodiments, an approximate second order cost function is minimized by application of a block inverse QR-recursive least squares algorithm which is based at least in part on processing multiple samples concurrently to obtain pre-array blocks including a term inversely proportional to a root mean square of the uplink signal for the multiple samples.

According to yet another aspect, a network node 16 is configured to reduce passive intermodulation, PIM, from a preexisting extent of PIM affecting performance of at least one wireless transceiver 28 of the network node 16. The network node 16 includes: at least one wireless transceiver 28 configured to: receive an uplink signal vector at a first frequency; and transmit a downlink signal vector at a second frequency. The network node 16 also includes processing circuitry 38 in communication with the at least one wireless transceiver 28, the processing circuitry 38 configured to: determine an uplink signal power based on the uplink signal vector; determine an estimate of a downlink PIM subspace that minimizes a function of: the downlink signal vector, a previous estimate of the downlink PIM subspace and the uplink signal power; and apply a correction to a downlink antenna signal to obtain the downlink signal vector, the downlink signal vector resulting in PIM that is less than a preexisting extent of PIM, the correction being based at least in part on the estimate of the downlink PIM subspace.

According to this aspect, in some embodiments, determining the estimate of the downlink PIM subspace includes estimating a PIM channel covariance matrix, the estimated PIM channel covariance matrix being based at least in part on a preselected number of eigenvectors. In some embodiments, the estimated PIM channel covariance matrix is based at least in part on a diagonal matrix of eigenvalues of the PIM channel covariance matrix. In some embodiments, the at least one wireless transceiver 28 includes a first wireless transceiver 28 configured to receive the uplink signal vector and a second wireless transceiver 28 configured to transmit the downlink signal vector.

According to another aspect, a method in a network node 16 configured to reduce passive intermodulation, PIM, from a preexisting extent of PIM affecting performance of at least one wireless transceiver 28 of the network node 16 is provided. The method includes: receiving an uplink signal vector at a first frequency; and transmitting a downlink signal vector at a second frequency. The method also includes determining an uplink signal power based on the uplink signal vector; determining an estimate of a downlink PIM subspace that minimizes a function of: the downlink signal vector, a previous estimate of the downlink PIM subspace and the uplink signal power; and applying a correction to a downlink antenna signal to obtain the downlink signal vector, the downlink signal vector resulting in PIM that is less than a preexisting extent of PIM, the correction being based at least in part on the estimate of the downlink PIM subspace.

According to this aspect, in some embodiments, determining the estimate of the downlink PIM subspace includes estimating a PIM channel covariance matrix, the estimated PIM channel covariance matrix being based at least in part on a preselected number of eigenvectors. In some embodiments, the estimated PIM channel covariance matrix is based at least in part on a diagonal matrix of eigenvalues of the PIM channel covariance matrix. In some embodiments, the at least one wireless transceiver 28 includes a first wireless transceiver 28 configured to receive the uplink signal vector and a second wireless transceiver 28 configured to transmit the downlink signal vector.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Some abbreviations used herein may include the following:
CSI Channel State Information
DL Downlink
FDD Frequency Division Duplex
LTE Long-Term Evolution
MIMO Multiple-Input Multiple-Output
NR New Radio
OFDM Orthogonal Frequency Division Multiplexing
ORAN Open Radio Access Network
PIM Passive Inter-Modulation
RLS Recursive Least-Squares
TDD Time Division Duplex
UE User Equipment
UL Uplink
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method for reducing passive intermodulation, PIM, in a wireless transceiver from a preexisting extent of PIM, the method comprising:
determining an uplink signal power;
determining an estimate of a downlink PIM subspace that minimizes a cost function that depends on the uplink signal power and a previous estimate of the downlink PIM subspace; and
applying a correction to a downlink antenna signal to reduce the PIM, the correction being based at least in part on the estimate of the downlink PIM subspace.

2. The method of claim 1, wherein the cost function includes subtracting from an antenna signal vector a signal contribution which lies in a downlink PIM subspace, the signal contribution being determined by a product of the antenna signal vector and an estimate of a downlink PIM subspace projection matrix.

3. The method of claim 2, wherein the estimate of the downlink PIM subspace projection matrix is generated by a product of the estimate of the downlink PIM subspace and a Hermitian transpose of the previous estimate of the downlink PIM subspace.

4. The method of claim 1, wherein the cost function is minimized by application of a gradient descent algorithm with an update term that includes a gradient determined using the previous estimate of the downlink PIM subspace weighted by a step factor.

5. The method of claim 1, wherein the cost function is minimized by application of a recursive least squares algorithm which is based at least in part on setting an approximate second order cost function gradient to zero.

6. The method of claim 1, wherein an approximate second order cost function is minimized by application of an inverse QR-recursive least squares algorithm which is based at least in part on a product of an antenna signal vector and the previous estimate of the downlink PIM subspace.

7. The method of claim 1, wherein an approximate second order cost function is minimized by application by an inverse QR-recursive least squares algorithm which is based at least in part on a pre-array including a term inversely proportional to a root mean square value of the uplink signal.

8. The method of claim 1, wherein an approximate second order cost function is minimized by application of a block inverse QR-recursive least squares algorithm which is based at least in part on processing multiple samples concurrently to obtain pre-array blocks including a term inversely proportional to a root mean square of the uplink signal for the multiple samples.

9. A wireless transceiver configured to reduce passive intermodulation, PIM, from a preexisting extent of PIM, the wireless transceiver comprising processing circuitry configured to:
determine an uplink signal power;
determine an estimate of a downlink PIM subspace that minimizes a cost function that depends on the uplink signal power and a previous estimate of the downlink PIM subspace; and
apply a correction to a downlink antenna signal to reduce the PIM, the correction being based at least in part on the estimate of the downlink PIM subspace.

10. The wireless transceiver of claim 9, wherein the cost function includes subtracting from an antenna signal vector a signal contribution which lies in a downlink PIM subspace, the signal contribution being determined by a product of the antenna signal vector and an estimate of a downlink PIM subspace projection matrix.

11. The wireless transceiver of claim 10, wherein the estimate of the downlink PIM subspace projection matrix is generated by a product of the estimate of the downlink PIM subspace and a Hermitian transpose of the previous estimate of the downlink PIM subspace.

12. The wireless transceiver of claim 9, wherein the cost function is minimized by application of a gradient descent algorithm with an update term that includes a gradient determined using the previous estimate of the downlink PIM subspace weighted by a step factor.

13. The wireless transceiver of claim 9, wherein the cost function is minimized by application of a recursive least squares algorithm which is based at least in part on setting an approximate second order cost function gradient to zero.

14. The wireless transceiver of claim 9, wherein an approximate second order cost function is minimized by application of an inverse QR-recursive least squares algorithm which is based at least in part on a product of an antenna signal vector and the previous estimate of the downlink PIM subspace.

15. The wireless transceiver of claim 9, wherein an approximate second order cost function is minimized by application by an inverse QR-recursive least squares algorithm which is based at least in part on a pre-array including a term inversely proportional to a root mean square value of the uplink signal.

16. The wireless transceiver of of claim 9, wherein an approximate second order cost function is minimized by application of a block inverse QR-recursive least squares algorithm which is based at least in part on processing multiple samples concurrently to obtain pre-array blocks including a term inversely proportional to a root mean square of the uplink signal for the multiple samples.

17. A network node configured to reduce passive intermodulation, PIM, from a preexisting extent of PIM affecting performance of at least one wireless transceiver of the network node, the network node comprising:
at least one wireless transceiver configured to:
receive an uplink signal vector at a first frequency; and
transmit a downlink signal vector at a second frequency; and
processing circuitry in communication with the at least one wireless transceiver, the processing circuit configured to:
determine an uplink signal power based on the uplink signal vector;
determine an estimate of a downlink PIM subspace that minimizes a function of:
the downlink signal vector, a previous estimate of the downlink PIM subspace and the uplink signal power; and
apply a correction to a downlink antenna signal to obtain the downlink signal vector, the downlink signal vector resulting in PIM that is less than a preexisting extent of PIM, the correction being based at least in part on the estimate of the downlink PIM subspace.

18. The network node of claim 17, wherein determining the estimate of the downlink PIM subspace includes estimating a PIM channel covariance matrix, the estimated PIM channel covariance matrix being based at least in part on a preselected number of eigenvectors.

19. The network node of claim 18, wherein the estimated PIM channel covariance matrix is based at least in part on a diagonal matrix of eigenvalues of the PIM channel covariance matrix.

20. The network node of claim 17,
wherein the at least one wireless transceiver includes a first wireless transceiver configured to receive the uplink signal vector and a second wireless transceiver configured to transmit the downlink signal vector.

21. A method in a network node configured to reduce passive intermodulation, PIM, from a preexisting extent of PIM affecting performance of at least one wireless transceiver of the network node, the method comprising:
receiving an uplink signal vector at a first frequency;
transmitting a downlink signal vector at a second frequency;
determining an uplink signal power based on the uplink signal vector;
determining an estimate of a downlink PIM subspace that minimizes a function of: the downlink signal vector, a previous estimate of the downlink PIM subspace and the uplink signal power; and
applying a correction to a downlink antenna signal to obtain the downlink signal vector, the downlink signal vector resulting in PIM that is less than a preexisting extent of PIM, the correction being based at least in part on the estimate of the downlink PIM subspace.

22. The method of claim 21, wherein determining the estimate of the downlink PIM subspace includes estimating a PIM channel covariance matrix, the estimated PIM channel covariance matrix being based at least in part on a preselected number of eigenvectors.

23. The method of claim 21, wherein the estimated PIM channel covariance matrix is based at least in part on a diagonal matrix of eigenvalues of the PIM channel covariance matrix.

24. The method of claim 21, wherein the at least one wireless transceiver includes a first wireless transceiver configured to receive the uplink signal vector and a second wireless transceiver configured to transmit the downlink signal vector.
